(19) United States
(12) Patent Application Publication
(10) Pub. No.: US 2017/0279199 A1
(43) Pub. Date: Sep. 28, 2017

(54) METAL BODY ANTENNA HAVING LOOP TYPE RADIATION ELEMENTS

(71) Applicant: ACE TECHNOLOGIES CORPORATION, Incheon (KR)

(72) Inventors: Sung Nam AN, Seoul (KR); Won Whi JIN, Bucheon-si (KR); Jun Hee KIM, Incheon (KR)

(21) Appl. No.: 15/454,002

(22) Filed: Mar. 9, 2017

(30) Foreign Application Priority Data
Mar. 23, 2016 (KR) 10-2016-0034362

(51) Int. Cl. H01Q 7/00; H01Q 5/335; H01Q 9/04; H01Q 1/48; H01Q 5/30

(52) U.S. Cl. CPC H01Q 7/00; H01Q 1/48; H01Q 5/30; H01Q 9/0485; H01Q 5/335

(57) ABSTRACT

A metal body antenna having loop type radiation elements in which a housing unit is used as an antenna includes a radiation element supplied with a signal from a feeding power port, a ground coupled to the radiation element by loop coupling and in which an induction current is generated, and a frame bezel unit having an open end part separated from the ground by a dielectric and a gap. The frame bezel unit having the open end part supplied with an electric current induced into the ground is connected, and the metal body antenna operates in a wideband in multiple bands having an electrical length of a half wavelength. Accordingly, the bezel unit of a frame unit is effectively used and all of the Penta bands (i.e., GSM850, EGSM, DCS, PCS, and W2100) used in mobile phones is satisfied through a wideband multi-antenna structure having a small radiation loss.

### CROSS-REFERENCE TO RELATED APPLICATION

This application claims priority to Korean patent application number 10-2016-0034362, filed Mar. 23, 2016, the entire disclosure of which is incorporated by reference herein.

### BACKGROUND OF THE INVENTION

1. Field of the Invention

The present invention relates to a metal body antenna having loop type radiation elements which operates in a wideband in multiple bands and, more particularly, to a metal body antenna including the housing unit of a terminal and loop type radiation elements having a wideband characteristic in multiple bands, wherein the end part of the radiation element supplied with a signal from a feeding power port formed in the housing unit is connected to a ground and the applied signal is connected to the ground by loop coupling.

2. Description of Related Art

With the recent rapid development of a communication technology, the size and weight of a communication device are reduced and performance of a communication device is further increased.

In particular, most of smart phones are rapidly evolving from the existing second-generation and third-generation communication methods, such as global system for mobile communication (GSM), code division multiple access (CDMA), and wideband CDMA (WCDMA), to a fourth-generation communication method, such as long term evolution (LTE). Furthermore, various technologies, such as Bluetooth, global positioning system (GPS), and Wi-Fi, are integrated.

A single mobile communication terminal may use a plurality of antennas to support various communication methods, but a wideband (or broadband) antenna technology capable of implementing multiple bands using a single antenna has been developed because there is a difficulty in disposing the plurality of antennas within the limited size of the terminal.

The wideband antenna technology has been proposed as a method for supporting various communication bands through the design of an antenna having a wide bandwidth. It is however impossible to improve efficiency of all of bands while implementing multiple bands based on a wide bandwidth. Furthermore, the space in various parts may be disposed is insufficient within the terminal because a wide space is required for the antenna design.

As a method for solving such a problem, a technology in which a housing unit forming an external appearance of a terminal is made of metal and the housing unit operates as an antenna was developed.

If the technology in which the housing unit operates as the antenna as described above is used, a space within the terminal can be additionally secured, more various parts can be disposed in the terminal using the additional space, and a thin type terminal design is made possible.

More specifically, antenna technologies using the housing unit as an antenna, that is, an antenna using a conductive bezel, and a metal battery cover has a disadvantage in that they have a narrow bandwidth. Accordingly, additional technologies, such as a tubable antenna technology in order to support various communication bands, have been additionally applied.

Furthermore, several problems, such as a rise of a production cost attributable to the application of the tubable antenna technologies, an increase of the design period attributable to added parts, and a rise of power consumption, are accompanied.

Accordingly, there is an urgent need for an antenna design technology which can utilize a space within the terminal as much as possible and achieve a smaller size and has a wide bandwidth even without using an additional technology by forming the casing of a housing unit forming an external appearance of the terminal using a metal material so that the housing unit operates as an antenna.

In order to solve such conventional problems, Korean Patent No. 10-1609542 entitled “Metal-Body Antenna to Operating Wideband in a Multi-Band” was proposed.

As the terminal tends to become slim, the PCB area of the terminal recently tends to be designed by avoiding parts, such as a speaker and a battery. In such a case, an extension cable is required because the feeding power port 8a of an existing antenna deviates from the area of a PCB 2a as shown in FIG. 1a, and there is a difficulty in the antenna design. In order to supplement such a disadvantage, there is a need for an antenna design in which a feeding power port 8b shown in FIG. 1b is disposed within the area of a PCB 2b.

### SUMMARY OF THE INVENTION

In accordance with an embodiment of the present invention, an object of the present invention is to provide a metal body antenna having loop type radiation elements, which has a small radiation loss and shows a wideband characteristic in multiple bands using a frame bezel unit.

In accordance with another embodiment of the present invention, another object of the present invention is to provide an antenna having loop type radiation elements and showing a wideband characteristic in multiple bands, wherein a radiation element supplied with a signal from a feeding power port is connected to a ground in a loop form without having a coupling structure in which the radiation element supplied with a signal from the feeding power port is coupled to a frame bezel unit as a radiation element connected to the ground.

In accordance with another embodiment of the present invention, an object of the present invention is to provide a metal body antenna having loop type radiation elements and showing a wideband characteristic in multiple bands, wherein when an electromagnetic signal is applied to a feeding power port, a radiation element is coupled to a ground by loop coupling to generate an induction current in the ground, electric energy is concentrated on the end part of an upper bezel unit due to a surface current flowing into a frame bezel unit as a radiation element connected to the ground due to an electric current induced into the ground, and magnetic energy is concentrated near a connection point that connects a side bezel unit and the ground.

In accordance with another embodiment of the present invention, another object of the present invention is to provide a metal body antenna having loop type radiation elements and showing a wideband characteristic in multiple bands, wherein an L-C element is inserted to a feeding power port and perfect impedance matching with the antenna unit is performed in an operating frequency band.

In a metal body antenna having loop type radiation elements in accordance with an embodiment of the present invention, a radiation element supplied with a signal from a feeding power port does not have a coupling structure along with a frame bezel unit as a radiation element connected to a ground, but a radiation element supplied with a signal from a feeding power port is coupled to a ground by loop coupling and operates in a wideband in multiple bands.

In accordance with another embodiment of the present invention, a metal body antenna having loop type radiation elements and operating in a wideband in multiple bands includes a housing unit adapted to form an external appearance of a terminal; a first antenna unit adapted to include a first radiation element supplied with an electromagnetic signal from a first feeding power port formed in the housing unit, a ground coupled to the first radiation element by loop coupling and formed in the housing unit in which an induction current is generated, a side bezel unit connected to the ground, and an upper bezel unit connected to the side bezel unit and having an end part open by a gap; and a second antenna unit adapted to include a second radiation element supplied with an electromagnetic signal from a second feeding power port formed in the housing unit, a ground coupled to the second radiation element by loop coupling and formed in the housing unit in which an induction current is generated, a side bezel unit connected to the ground, and an upper bezel unit connected to the side bezel unit and having an end part open by a gap.

In accordance with another embodiment of the present invention, a metal body antenna having loop type radiation elements includes first and second radiation elements supplied with signals from feeding power ports; a ground coupled to the first and the second radiation elements by loop coupling, an induction current being generated in the ground; a bezel unit separated by the ground and a dielectric; side bezel units of the bezel unit supplied with the induction current of the ground; and an upper bezel unit connected to the side bezel units and having end parts open by gaps formed in an upper frame, wherein the first and second antenna units operate in a wideband in multiple bands having an electrical length of a half wavelength.

In accordance with another embodiment of the present invention, a metal body antenna having loop type radiation elements and operating in a wideband in multiple bands, wherein the metal body antenna includes a rectangular ground surface made of a metal material and an upper frame bezel unit made of a metal material and surrounding an outermost edge part of the rectangular ground surface, the metal body antenna being formed in a housing unit of a terminal and including a dielectric formed in a specific width between the rectangular ground surface and the upper frame bezel unit; gaps each formed to maintain a specific opening at a specific portion of the upper frame bezel unit of the housing unit; a first antenna unit adapted to include a first feeding power port which is a first port formed in a specific portion adjacent to the dielectric above the ground surface, a first radiation element connected to the first feeding power port, and supplied with an electromagnetic signal, and having an end part disconnected at a specific height with respect to the ground surface, a ground coupled to the first radiation element by loop coupling, supplied with an electromagnetic signal to generate an induction current, and formed below the first radiation element, a side bezel unit of the upper frame bezel unit connected to the ground by a connection point and separated by the dielectric, and an upper bezel unit connected to the side bezel unit and having an end part by the gap; and a second antenna unit adapted to include a second feeding power port which is a second port formed in a specific portion adjacent to the dielectric above the ground surface, a second radiation element connected to the second feeding power port, and supplied with an electromagnetic signal, and having an end part disconnected at a specific height with respect to the ground surface, a ground coupled to the second radiation element by loop coupling, supplied with an electromagnetic signal to generate an induction current, and formed below the second radiation element, a side bezel unit of the upper frame bezel unit connected to the ground by a connection point and separated by the dielectric, and an upper bezel unit connected to the side bezel unit and having an end part by the gap.

In accordance with another embodiment of the present invention, a metal body antenna having loop type radiation elements and operating in a wideband in multiple bands includes a housing unit adapted to form an external appearance of a terminal; a first antenna unit adapted to include a first radiation element supplied with an electromagnetic signal from a first feeding power port formed in the housing unit, a ground coupled to the first radiation element by loop coupling and formed in the housing unit in which an induction current is generated, a side bezel unit connected to the ground, and an upper bezel unit connected to the side bezel unit and having an end part open by a gap; and a second antenna unit adapted to include a second radiation element supplied with an electromagnetic signal from a second feeding power port formed in the housing unit, a ground coupled to the second radiation element by loop coupling and formed in the housing unit in which an induction current is generated, a side bezel unit connected to the ground, and an upper bezel unit connected to the side bezel unit and having an end part open by a gap.

### BRIEF DESCRIPTION OF THE DRAWINGS

FIG. 1a is a case where a radiation element according to a conventional technology is a monopole type and shows the configuration of parts of a mobile terminal.

FIG. 1b is a case where a radiation element according to an embodiment of the present invention is a loop type and shows the configuration of parts of a mobile terminal.

FIG. 2 is a plan view showing a representative structure of a metal body antenna having loop type radiation elements formed in the housing unit of the terminal in accordance with an embodiment of the present invention.

FIG. 3a is a case where the radiation element connected to a feeding power port is linear in FIG. 2 and is a detailed plan view showing an enlarged structure of the metal body antenna having loop type radiation elements.

FIG. 3b is a case where the radiation element connected to the feeding power port is linear in FIG. 2 and is a detailed perspective view showing an enlarged structure of the metal body antenna having loop type radiation elements.

FIG. 3c is a case where the radiation element connected to the feeding power port is linear in FIGS. 3a and 3b and shows a reflection loss of the metal body antenna.

FIG. 4a is a case where the radiation element connected to the feeding power port is linear and reduced in size in FIG. 2 and is a detailed plan view showing an enlarged structure of the metal body antenna having loop type radiation elements.

FIG. 4b is a case where the radiation element connected to the feeding power port is linear and reduced in size in FIG. 2 and is a detailed perspective view showing an enlarged structure of the metal body antenna having loop type radiation elements.

FIG. 4c is a case where the radiation element connected to the feeding power port is linear and reduced in size in FIGS. 4a and 4b and shows a reflection loss of the metal body antenna.

FIG. 5a is a case where the radiation element connected to the feeding power port is linear and reduced in size in FIG. 2 and is a detailed plan view showing an enlarged structure of the metal body antenna having loop type radiation elements.

FIG. 5b is a case where the radiation element connected to the feeding power port is linear and reduced in size in FIG. 2 and is a detailed perspective view showing an enlarged structure of the metal body antenna having loop type radiation elements.

FIG. 5c is a case where the radiation element connected to the feeding power port is linear and reduced in size in FIGS. 5a and 5b and shows a reflection loss of the metal body antenna.

### DETAILED DESCRIPTION OF THE EMBODIMENTS

Hereinafter, embodiments of the present invention will be described in detail with reference to the accompanying drawings. The same elements are assigned the same reference numerals. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Embodiments of a metal body antenna are described in detail below with reference to the accompanying drawings.

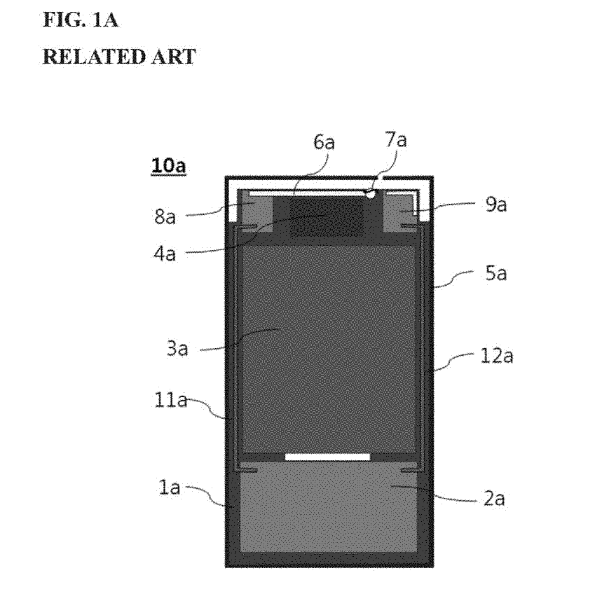

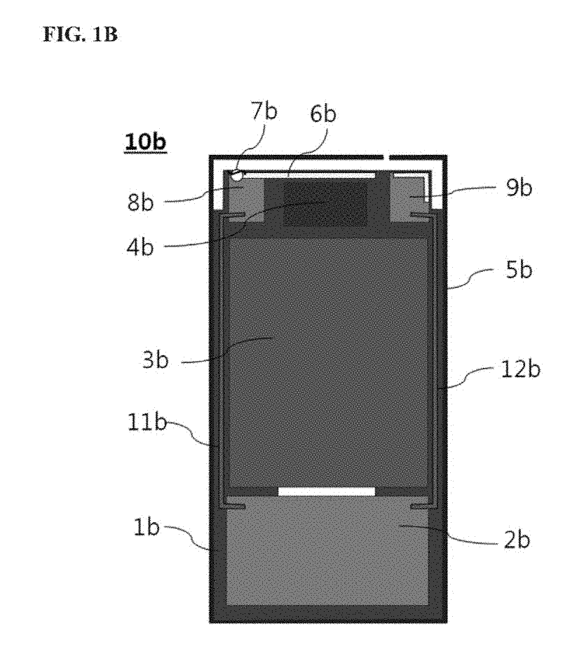

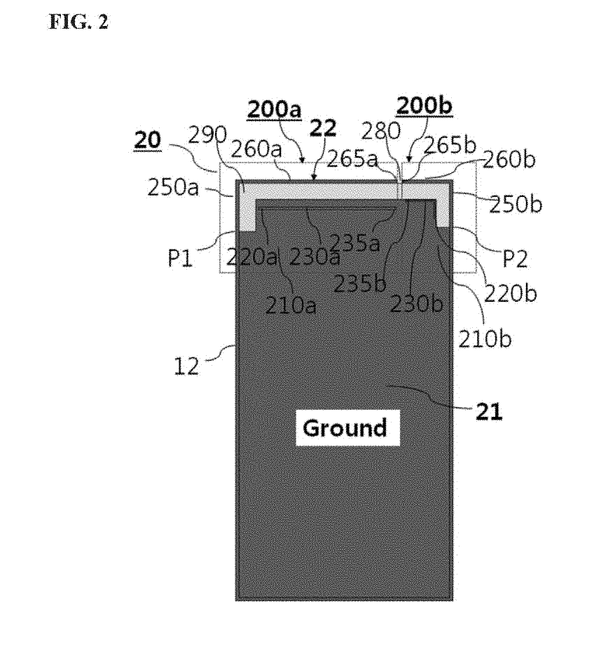

FIG. 1a is a case where a radiation element according to a conventional technology is a monopole type and shows the configuration of parts of a mobile terminal. FIG. 2 is a plan view showing a representative structure of a metal body antenna having loop type radiation elements formed in the housing unit of the terminal in accordance with an embodiment of the present invention.

Referring to FIGS. 1b and 2, the metal body antenna having loop type radiation elements according to an embodiment of the present invention is mounted on the housing unit 20 of a terminal. The housing unit 20 includes a rectangular ground 21 made of a metal material and formed to occupy most of the area of the housing unit 20 and a frame bezel unit 22 on the upper side made of a metal material and formed to surround the outermost edge part of the rectangular ground.

The ground 21 of the housing unit 20 provides a ground voltage within the terminal and may form a board on which circuit elements and parts necessary for the operation of the terminal are mounted.

More specifically, referring to FIG. 2, the metal body antenna formed in the housing unit 20 according to an embodiment of the present invention includes grounds 210a and 210b of a ground region on the upper side indicated by dotted lines, first and second feeding power ports 220a and 220b including two ports, two first and second radiation elements 230a and 230b, a side bezel unit 250 of a side part frame, that is, first and second side bezel units 250a and 250b formed in the side frame bezel unit 250 in the upper frame bezel unit 22 of an edge part in the upper outermost part of the rectangular ground of the housing unit, first and second bezel units 260a and 260b formed in the upper bezel unit 260 of the upper frame bezel unit 22, and a gap 280 and dielectric 290 formed in the first and the second bezel units 260a and 260b.

Furthermore, the metal body antenna configured to have loop type radiation elements and formed in the housing unit 20 according to an embodiment of the present invention includes a first antenna unit 200a operating in a low frequency band and a second antenna unit 200b operating in a high frequency band.

That is, in accordance with an embodiment of the present invention, each of the first and the second antenna units 200a and 200b is an antenna having an electrical length of a half wavelength. That is, the metal body antenna according to an embodiment of the present invention is formed dually or solely like the first antenna unit 200a and the second antenna unit 200b. The first antenna unit 200a operates in a low frequency band and the second antenna unit 200b operates in a high frequency band, and thus the metal body antenna operates in a wideband in multiple bands. The first antenna unit 200a operates at 824 MHz-960 MHz, that is, a frequency of GSM850 and EGSM of a low frequency band. The second antenna unit 200b operates at 1710 MHz 2170 MHz, that is, a frequency of DCS, PCS or W2100 of a high frequency band.

The first antenna unit 200a includes the ground 210a, the first feeding power port 220a, the first radiation element 230a, the first side bezel unit 250a, the first bezel unit 260a, the gap 280, and the dielectric 290 in the upper ground region indicated by the dotted lines. Accordingly, the first antenna unit 200a is formed so that the end part 265a of the first bezel unit 260a is opened by the gap 280.

Furthermore, the second antenna unit 200b includes the ground 210b, the second feeding power port 220b, the second radiation element 230b, the second side bezel unit 250b, the second bezel unit 260b, the gap 280, and the dielectric 290 in the upper ground region indicated by the dotted lines. Accordingly, the second antenna unit 200b is formed so that the end part 265b of the second bezel unit 260b is open by the gap 280.

The two first and the second feeding power ports 220a and 220b are formed to be not connected to the grounds 210a and 210b of the upper ground region indicated by the dotted lines, that is, the ground 21 on the upper side which neighbors the dielectric 290, and thus function to supply an electromagnetic signal from the RF module of a terminal to the first and the second antenna units 200a and 200b.

Furthermore, in some embodiments, L-C elements are inserted into the first and the second feeding power ports 220a and 220b, respectively, so that the first and the second feeding power ports 220a and 220b are perfectly matched with the first and the second antenna units 200a and 200b in respective operating frequency bands, thereby achieving impedance matching.

The first radiation element 230a is connected to the first feeding power port 220a and supplied with an electromagnetic signal. The first radiation element 230a has a specific height and length with respect to the ground 210a and is configured to have an end part 235a disconnected.

The second radiation element 230b is connected to the second feeding power port 220b and supplied with an electromagnetic signal. The second radiation element 230b has a specific height and length with respect to the ground 210b and is configured to have an end part 235b disconnected.

The first and the second radiation elements 230a and 230b may be formed above the ground 21 or the dielectric 290 in order to utilize the space of the housing unit 20.

Accordingly, the first and the second radiation elements 230a and 230b supplied with electromagnetic signals from the first and the second feeding power ports 220a and 220b transfer the electromagnetic signals to the grounds 210a and 210b by loop coupling.

The first and the second side bezel units 250a and 250b are formed in the left and right surfaces of the frame bezel unit 22 in the outermost edge part of the housing unit. The first and the second side bezel units 250a and 250b are connected to the grounds 210a and 210b to which an electromagnetic signal from the radiation elements 230a and 230b is supplied at connection points P1 and P2 by loop coupling, and transfer the electromagnetic signal to the first and the second bezel units 260a and 260b of the first and the second antenna units 200a and 200b.

Accordingly, the first and the second radiation elements 230a and 230b are formed on both sides of grounds 210a and 210b based on the connection points P1 and P2, respectively, and operate in a wideband in multiple bands.

Furthermore, the upper bezel unit 260 is connected to the first and the second side bezel units 250a and 250b and is the upper bezel unit 260 of the upper frame bezel unit 22 in the upper outermost edge part of the housing unit 20. The upper bezel unit 260 includes the first bezel unit 260a on the upper left side of the first antenna unit 200a and the second bezel unit 260b on the upper right side of the second antenna unit 200b.

In the case of the first antenna unit 200a, the first bezel unit 260a is horizontally formed on the upper part as the upper bezel unit 260 of the frame bezel unit 22 extended to the end corner part of the first side bezel unit 250a of the left surface. In the case of the second antenna unit 200b, the second bezel unit 260b is horizontally formed on the upper part as upper bezel unit 260 of the frame bezel unit 22 extended to the end corner part of the second side bezel unit 250b of the right surface.

The gap 280 is formed to maintain a specific opening at a specific location of the upper bezel unit 260 so that the first and the second bezel units 260a and 260b are separated. Accordingly, the open end parts 265a and 265b are formed in the first and the second bezel units 260a and 260b, respectively.

The dielectric 290 formed to have a specific width is provided between the rectangular ground 21 and the upper frame bezel unit 22 including the first and the second side bezel units 250a and 250b connected to the first and the first bezel units 260a and 260b by the gap 280.

Accordingly, the upper frame bezel unit 22, including the first and the second side bezel units 250a and 250b of the bezel unit 250 of the side unit and the first and the second bezel units 260a and 260b of the upper bezel unit 260, is separated from the ground 21 by the gap 280 and the dielectric 290.

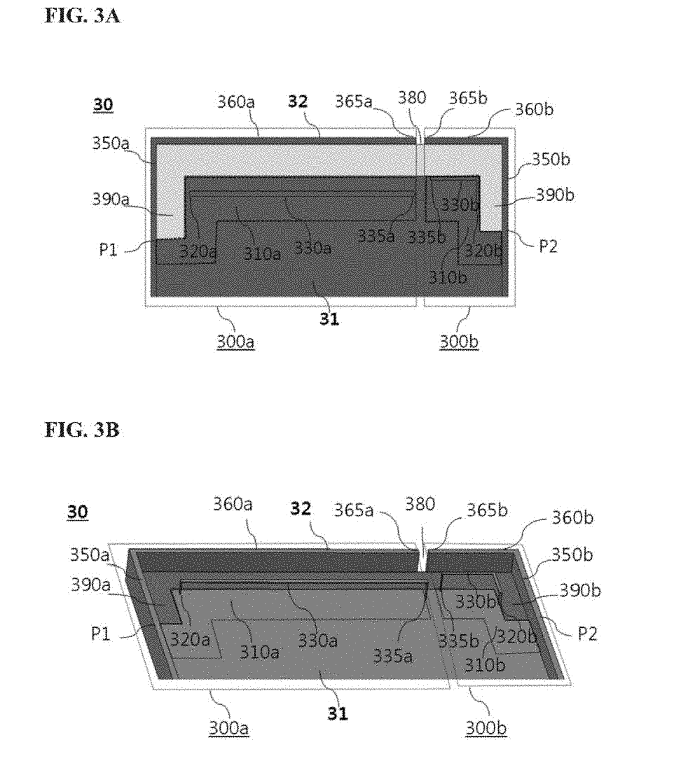

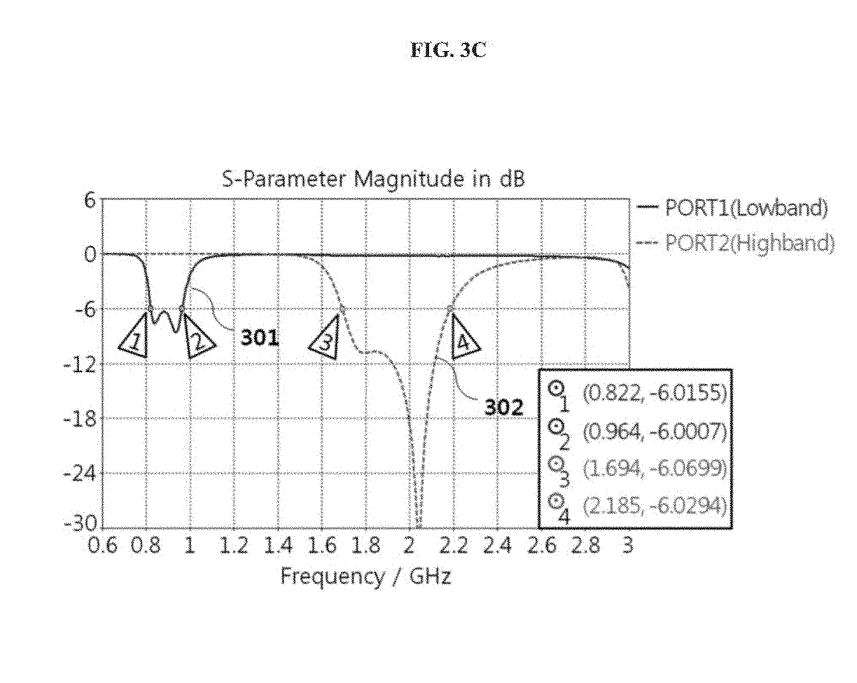

FIG. 3a is a case where the radiation element connected to the feeding power port is linear in FIG. 2 and is a detailed plan view showing an enlarged structure of the metal body antenna having loop type radiation elements. FIG. 3b is a case where the radiation element connected to the feeding power port is linear in FIG. 2 and is a detailed perspective view showing an enlarged structure of the metal body antenna having loop type radiation elements.

The metal body antenna having loop type radiation elements according to an embodiment of the present invention is described in detail with reference to FIGS. 2, 3a, and 3b.

The metal body antenna formed in the housing unit 20 having loop type radiation elements according to an embodiment of the present invention includes the grounds 210a and 210b of the upper ground region indicated by the dotted lines, the first and the second feeding power ports 220a and 220b including two ports, the two first and the second radiation elements 230a and 230b, the side bezel unit 250 of a side part frame, that is, the first and the second side bezel units 250a and 250b formed in the side frame bezel unit 250 of the upper frame bezel unit 22 at the edge parts of the upper outermost part of the rectangular ground of the housing unit, the first and the second bezel units 260a and 260b formed in the upper bezel unit 260 of the upper frame bezel unit 22, and the gap 280 and the dielectric 290 formed in the first and the second bezel units 260a and 260b.

In accordance with an embodiment of the present invention, FIG. 3a relates to a metal body antenna having a linear structure in which the first and the second radiation elements 330a and 330b are radiation elements connected to the feeding power ports in FIG. 2. Accordingly, in some embodiments, the first and the second radiation elements 330a and 330b in the structure of FIGS. 3a and 3b are also called first and second linear radiation elements 330a and 330b.

The metal body antenna formed in the housing unit 30, having loop type radiation elements, according to an embodiment of the present invention includes a first antenna unit 300a operating in a low frequency band and a second antenna unit 300b operating in a high frequency band.

That is, in accordance with an embodiment of the present invention, each of the first and the second antenna units 300a and 300b is an antenna having an electrical length of a half wavelength. The metal body antenna according to an embodiment of the present invention is formed dually or solely like the first antenna unit 300a and the second antenna unit 300b. The first antenna unit 300a operates in a low frequency band and the second antenna unit 300b operates in a high frequency band, thus operating in a wideband in multiple bands. The first antenna unit 300a operates at 824 MHz˜960 MHz, that is, a frequency of GSM850 and EGSM of a low frequency band. The second antenna unit 300b operates at 1710 MHz˜2170 MHz, that is, a frequency of DCS, PCS or W2100 of a high frequency band.

In the metal body antenna of FIGS. 3a and 3b according to an embodiment of the present invention, first and second radiation elements 330a and 330b have a linear structure, and the end parts 365a and 265b of a first bezel unit 360a and a second bezel unit 360b are adjacent to each other with a gap 380 interposed therebetween.

The configuration of the first antenna unit 300a is described below. The first antenna unit 300a operates in a low frequency band, and includes the first linear radiation element 330a, a ground 310a, that is, an upper ground region indicated by dotted lines, a first connection point P1, a first side bezel unit 350a, the first bezel unit 360a, the gap 380, and a dielectric 390a.

A first feeding power port 320a connected to the first linear radiation element 330a is located at a place close to the first connection point P1 and is formed to be not connected to the ground 310a at a specific portion of the ground 31 of the upper ground region which is adjacent to the dielectric 390a and indicated by the dotted lines. Accordingly, the first feeding power port 320a supplies an electromagnetic signal of a low frequency band from the RF module of a terminal to the first antenna unit 300a.

Furthermore, in some embodiments, an L-C element is inserted into the first feeding power port 320a so that perfect matching with the first antenna unit 300a is performed in a low frequency band, thereby achieving impedance matching.

The first linear radiation element 330a is connected to the first feeding power port 320a and supplied with an electromagnetic signal. The first linear radiation element 330a is linearly formed at a specific height with respect to the ground 310a on the upper side and is formed to have a disconnected end part 335b. Accordingly, when the first linear radiation element 330a supplied with the electromagnetic signal from the first feeding power port 320a transfers the electromagnetic signal to the ground 310a by loop coupling, an induction current is generated in the ground 310a. The end part 335a of the disconnected first linear radiation element 330a is located at a point close to the end part 365a of the first bezel unit 360a.

The first radiation element 330a may be formed above the ground 310a or the dielectric 390a in order to utilize the space of the housing unit 30.

The first connection point P1 connects the ground 310a of the upper ground region indicated by the dotted lines and the first side bezel unit 350a, that is, the frame bezel unit 350 on the left surface of the upper frame bezel unit 32. The first connection point P1 connects the ground 310a and the first side bezel unit 350a.

Accordingly, an electromagnetic signal is transferred from the ground 310a to the first side bezel unit 350a of the first antenna unit 300a by the first connection point P1. The first connection point P1 becomes the start point of the first side bezel unit 350a.

Furthermore, the first side bezel unit 350a of the first antenna unit 300a transfers the electromagnetic signal, transferred by the first connection point P1, to the first bezel unit 360a of the upper frame bezel unit 32 which surrounds an edge part in the upper outermost part of the rectangular ground 31.

The first bezel unit 360a is connected to the end corner part of the first side bezel unit 350a, vertical to the first side bezel unit 350a, and horizontally formed on the upper part of the upper bezel unit 360 of the upper frame bezel unit 32. The open end part 365a is formed in the first bezel unit 360a.

The gap 380 is formed to maintain a gap at a specific location of the upper bezel unit 360, and forms the open end part 365a of the first bezel unit 360a.

The dielectric 390a formed to have a specific width is provided between the upper frame bezel unit 32 and the rectangular ground 31 separated by the gap 380.

That is, the frame bezel unit 32, including the first side bezel unit 350a of the side bezel unit 350 on the left surface and the first bezel unit 360a of the upper bezel unit 360, is separated from the ground 31 by the gap 380 and the dielectric 390a.

Accordingly, the first antenna unit 300a includes the first feeding power port 320a, that is, a first port formed to be not connected to the ground 310a of the upper ground region adjacent to the dielectric 390a and indicated by the dotted lines; the first linear radiation element 330a connected to the first feeding power port 320a, supplied with an electromagnetic signal, and formed to have the linearly disconnected end part 335a at a specific height with respect to the ground 310a; the ground 310a connected to the first linear radiation element 330a by loop coupling, supplied with an electromagnetic signal, and formed below the first linear radiation element 330a from which an induction current is generated; the first side bezel unit 350a of the bezel unit 350, that is, a side part of the frame bezel unit 32 connected to the ground 310a at the first connection point P1; and the open end part 365a of the first bezel unit 360a, that is, the left frame of the upper bezel unit 360 connected to the first side bezel unit 350a.

An operating principle according to the configuration of the first antenna unit 300a is described below.

When an electromagnetic signal is applied to the first feeding power port 320a, the first linear radiation element 330a is coupled to the ground 310a by loop coupling, and thus an induction current is generated in the ground 310a. An electric current induced into the ground 310a flows into the first bezel unit 360a through the first side bezel unit 350a by the first connection point P1. Electric energy is concentrated on the end part 365a of the first bezel unit 360a due to a flow of a surface current, and magnetic energy is concentrated around the first connection point P1 that connects the first side bezel unit 350a and the ground 310a. The first antenna unit 300a has an electrical length of a half wavelength in an operating frequency of a low frequency band and shows a wideband characteristic, such as a reflection loss 301 indicated by a solid line 301 in FIG. 3c.

The configuration of the second antenna unit 300b is described below. The second antenna unit 300b operates in a high frequency band, and includes the second linear radiation element 330b, the ground 310b, the second connection point P2, the second side bezel unit 350b, the second bezel unit 360b, the gap 380, and a dielectric 390b.

The second feeding power port 320b connected to the second linear radiation element 330b is located at a place close to the second connection point P2 and is formed to be not connected to the ground 310b of the upper ground region adjacent to the dielectric 390b and indicated by dotted lines. Accordingly, the second feeding power port 320b supplies an electromagnetic signal of a high frequency band from the RF module of a terminal to the second antenna unit 300b.

Furthermore, in some embodiments, an L-C element is inserted into the second feeding power port 320b so that perfect matching with the second antenna unit 300b is performed in a high frequency band, thereby achieving impedance matching.

The second linear radiation element 330b is connected to the second feeding power port 320b, supplied with an electromagnetic signal, and formed to have the linearly disconnected end part 335b at a specific height with respect to the ground 310b on the upper side. Accordingly, when the second linear radiation element 330b supplied with an electromagnetic signal from the second feeding power port 320a transfers the electromagnetic signal to the ground 310a by loop coupling, an induction current is generated in the ground 310a. The disconnected end part 335b of the second linear radiation element 330b is located at a place close to the end part 365b of the second bezel unit 360b.

The second radiation element 330b may be formed above the ground 310b or the dielectric 390b in order to utilize the space of the housing unit 30.

The second connection point P2 connects the ground 310b and the side bezel unit 350, that is, a side part frame of the upper frame bezel unit 32. The second connection point P2 connects the ground 310b and the second side bezel unit 250b on the right surface of the frame bezel unit 32.

Accordingly, an electromagnetic signal is transferred from the ground 310b to second side bezel unit 350b of the second antenna unit 300b by the second connection point P2. The second connection point P2 becomes the start point of the second side bezel unit 350b.

Furthermore, the second side bezel unit 350b of the second antenna unit 300b transfers the electromagnetic signal, transferred by the second connection point P2, to the second bezel unit 360b of the upper bezel unit 360 that surrounds the edge part of the upper outermost part of the rectangular ground 31.

The second bezel unit 360b is connected to the end corner part of the second side bezel unit 350b, vertical to the second side bezel unit 350b, and horizontally formed on the upper right side of the upper frame 360 of the upper frame bezel unit 32. The open end part 365b is formed in the second bezel unit 360b.

The gap 380 is formed to maintain a gap at a specific location of the upper bezel unit 360, and forms the open end part 365b of the second bezel unit 360b.

The dielectric 390b formed to have a specific width is provided between the upper frame bezel unit 32 and the rectangular ground 31 upward separated by the gap 380.

That is, the upper frame bezel unit 32, including the second side bezel unit 350b of the side bezel unit 350 of the right surface and the right second bezel unit 360b of the upper bezel unit 360, is separated from the ground 31 by the gap 380 and the dielectric 390b.

Accordingly, the second antenna unit 300b includes the second feeding power port 320b, that is, a second port formed to be not connected to the ground 310b at a specific portion on the upper part of the ground 310b adjacent to the dielectric 390b; the second linear radiation element 330b connected to the second feeding power port 320b, supplied with an electromagnetic signal, and equipped with the linearly disconnected end part 335b at a specific height with respect to the ground 310b; the ground 310b coupled to the second linear radiation element 330b by loop coupling, supplied with an electromagnetic signal, and formed below the second linear radiation element 330b from which an induction current is generated; the second side bezel unit 350b of the bezel unit 350 on the side part of the frame 32 connected to the ground 310b by the second connection point P2; and the disconnected end part 365b of the second bezel unit 360b of the upper bezel unit 360 connected to the second side bezel unit 350b, that is, the right frame of the second connection point P2.

Accordingly, the first and the second linear radiation elements 330a and 330b are formed on both sides of the grounds 310a and 310b based on the gap 380 and the first and the second connection points P1 and P2, and operate in a wideband in multiple bands.

An operating principle according to the configuration of the second antenna unit 300b is described below. When an electromagnetic signal is applied to the second feeding power port 320b, the second linear radiation element 330b is coupled to the ground 310b by loop coupling, and an induction current is generated in the ground 310b. An electric current induced into the ground 310b flows into the second bezel unit 360b through the second side bezel unit 350b by the second connection point P2. Electric energy is concentrated on the end part 365b of the second bezel unit 360b due to a flow of a surface current, and magnetic energy is concentrated around the second connection point P2 that connects the second side bezel unit 350b and the ground 310b. The second antenna unit 300b has an electrical length of a half wavelength in an operating frequency of a high frequency band, and shows a wideband characteristic, such as a reflection loss indicated by dotted lines 302 of FIG. 3c.

FIG. 3c is a diagram showing a reflection loss of the metal body antenna having loop type radiation elements shown in FIGS. 3a and 3b.

Referring to FIG. 3c, the range of an operating frequency in a low frequency band is from about 822 MHz to about 964 MHz based on a reflection loss −6 dB indicated by the solid line 301, and includes 824 MHz to 960 MHz, that is, the frequency section of GSM850 and EGSM. Furthermore, the range of an operating frequency in a high frequency band is from about 1694 MHz to about 2185 MHz based on a reflection loss −6 dB indicated by the dotted lines 302, and includes 1710 MHz to 2170 MHz, that is, the frequency section of DCS, PCS and W2100.

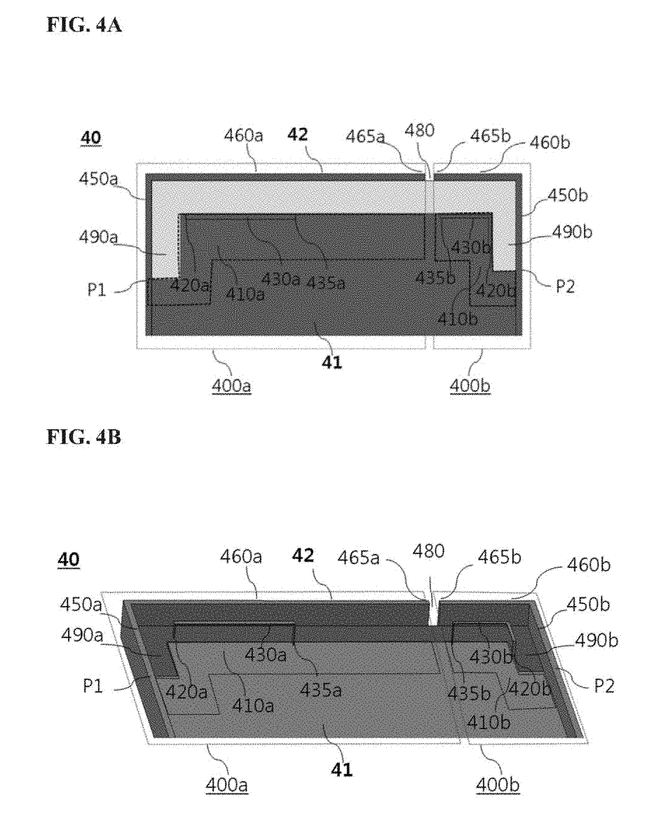

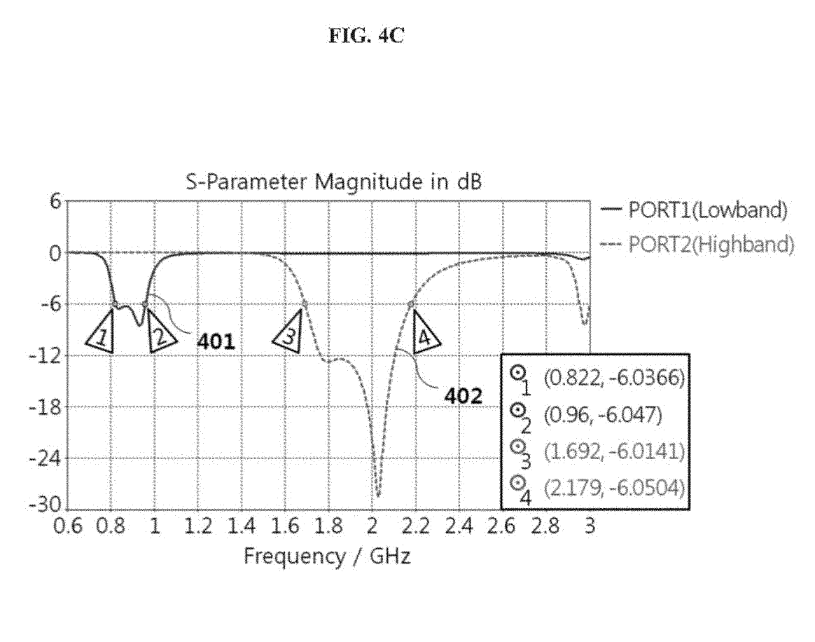

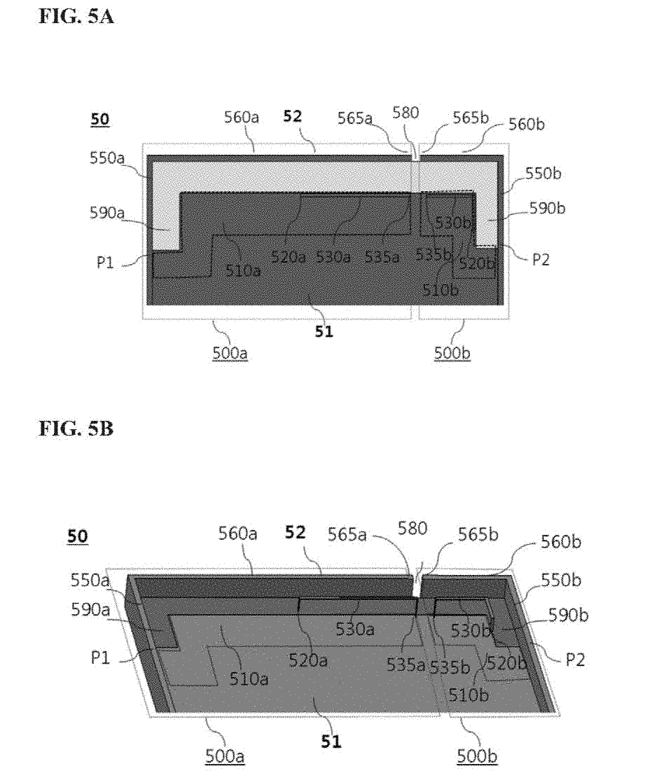

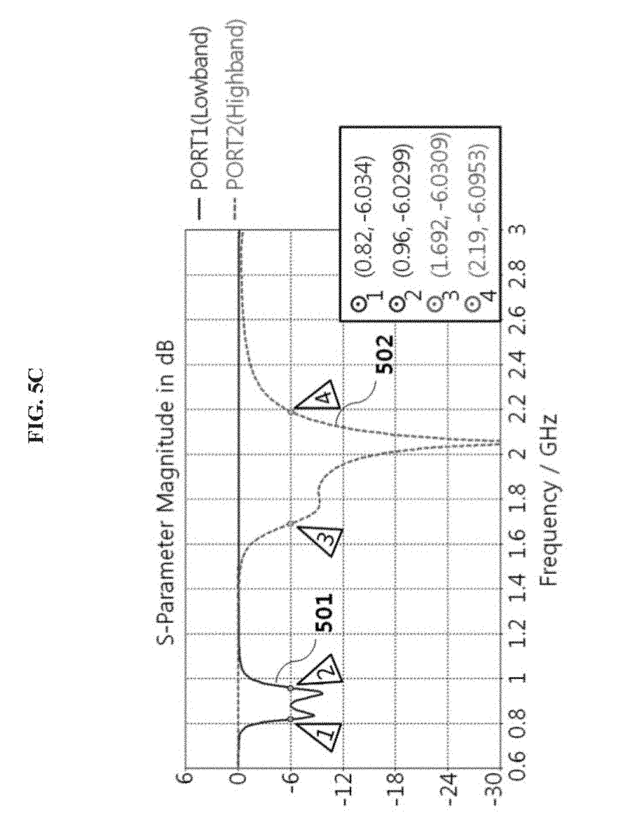

In a metal body antenna having loop type radiation elements according to another embodiment of the present invention, as in embodiments of FIGS. 4 and 5, the loop type radiation element can be reduced in size and may be disposed at a specific location between the end part of a bezel and connection points P1 and P2.

FIGS. 4a and 4b are diagrams showing the structure of a metal body antenna having loop type radiation elements according to another embodiment of the present invention. FIG. 4a is a plan view showing a detailed and enlarged structure of the metal body antenna in which the end part 435a of a first radiation element 430a is located in the middle between a first connection point P1 and the end part 465a of a first bezel unit 460a. FIG. 4b is a perspective view showing a detailed and enlarged structure of the metal body antenna having small-sized loop type radiation elements in which the end part 435a of the first radiation element 430a is located in the middle between the first connection point P1 and the end part 465a of the first bezel unit 460a.

The structure of FIGS. 4a and 4b is a structure for reducing the size of an antenna unit by securing a space within the housing unit 40, that is, by securing a space on which other elements and parts for a terminal are to be mounted.

In the metal body antenna having loop type radiation elements of FIGS. 4a and 4b according to another embodiment of the present invention, the first radiation element 430a has a small-sized linear structure. The first and the second side bezel units 450a and 450b of first and second antenna units 400a and 400b transfer electromagnetic signals, transferred by first and second connection points P1 and P2, to the first and the second bezel units 460a and 460b of an upper frame bezel unit 42 that surrounds edge parts in the upper outermost part of a rectangular ground 41.

Accordingly, the first radiation element 430a may be disposed at a specific location within the space between the first connection point P1 and the end part 465a of the first bezel unit 460a.

An operating principle of the metal body antenna having loop type radiation elements using the small-sized radiation elements shown in FIGS. 4a and 4b is the same as that of the antenna using the linear radiation elements shown in FIG. 3a.

FIG. 4c is a diagram showing a reflection loss of the metal body antenna having loop type radiation elements using the small-sized radiation elements shown in FIGS. 4a and 4b.

Referring to FIG. 4c, the range of an operating frequency in a low frequency band is from about 822 MHz to about 960 MHz based on a reflection loss −6 dB indicated by a solid line 401, and includes 824 MHz to 960 MHz, that is, the frequency section of GSM850 and EGSM. The range of an operating frequency in a high frequency band is from about 1692 MHz to about 2179 MHz based on a reflection loss −6 dB indicated by dotted lines 402, and includes 1710 MHz to 2170 MHz, that is, the frequency section of DCS, PCS or W2100.

FIGS. 5a and 5b are diagrams showing the structure of a metal body antenna having loop type radiation elements according to yet another embodiment of the present invention. FIG. 5a is a plan view showing a detailed and enlarged structure of a metal body antenna having small-sized loop type radiation elements in which the first feeding power port 520a of a first radiation element 530a is located in the middle between a first connection point P1 and the end part 565a of a first bezel unit 560a. FIG. 5b is a perspective view showing a detailed and enlarged structure of the metal body antenna having small-sized loop type radiation elements in which the first feeding power port 520a of the first radiation element 530a is located in the middle between the first connection point P1 and the end part 565a of the first bezel unit 560a.

In the metal body antenna having loop type radiation elements of FIGS. 5a and 5b according to yet another embodiment of the present invention, the first radiation element 530a has a small-sized linear structure. The first and second side bezel units 550a and 550b of first and second antenna units 500a and 500b transfer electromagnetic signals, transferred by the first and the second connection points P1 and P2, to the first and the second bezel units 560a and 560b of an upper frame bezel unit 52 that surrounds edge parts in the upper outermost part of the rectangular ground 51.

Accordingly, the first radiation element 530a may be disposed at a specific location in the space between the first connection point P1 and the end part 565a of the first bezel unit 560a. The second radiation element 530b may be disposed at a specific location in the space between the second connection point P2 and the end part 565b of the second bezel unit 560b.

An operating principle of the metal body antenna having loop type radiation elements using the small-sized radiation elements shown in FIGS. 5a and 5b is the same as that of the antenna using the linear radiation element shown in FIG. 3a.

FIG. 5c is a diagram showing a reflection loss of the metal body antenna having loop type radiation elements using the small-sized radiation elements shown in FIGS. 5a and 5b.

Referring to FIG. 5c, the range of an operating frequency in a low frequency band is from about 820 MHz to about 960 MHz based on a reflection loss −6 dB indicated by a solid line 501, and includes 824 MHz to 960 MHz, that is, the frequency section of GSM850 and EGSM. The range of an operating frequency in a high frequency band is from about 1692 MHz to about 2190 MHz based on a reflection loss −6 dB indicated by dotted lines 502, and includes 1710 MHz to 2170 MHz, that is, the frequency section of DCS, PCS and W2100.

As described above, the metal body antenna having loop type radiation elements according to an embodiment of the present invention has an advantage in that it shows a wideband characteristic in the Penta Band (i.e., GSM850, EGSM, DCS, PCS, and W2100), that is, a band chiefly used in mobile phones because the metal body antenna has a multi-antenna structure of a wideband using the frame bezel unit and having a small radiation loss.

Furthermore, the metal body antenna having loop type radiation elements according to an embodiment of the present invention has an advantage in that it shows a wideband characteristic in multiple bands because the radiation element supplied with a signal from the feeding power port is not coupled to the frame bezel unit as a radiation element coupled to the ground, but the radiation element supplied with a signal from the feeding power port is coupled to the ground by loop coupling.

Furthermore, the metal body antenna having loop type radiation elements according to an embodiment of the present invention has an advantage in that it shows a wideband characteristic in multiple bands because when an electromagnetic signal is applied to the feeding power port, the radiation element is coupled to the ground by loop coupling to generate an induction current in the ground, electric energy is concentrated on the end part of the upper bezel unit due to a surface current that flows into the frame bezel unit as a radiation element connected to the ground due to an electric current induced into the ground, and magnetic energy is concentrated near the connection point that connects the side bezel unit and the ground.

Furthermore, the metal body antenna having loop type radiation elements according to an embodiment of the present invention has an advantage in that it shows a wideband characteristic in multiple bands because the L-C element is inserted into the feeding power port and perfect impedance matching with the antenna unit is performed in an operating frequency band.

Although the embodiments of the present invention have been described in detail so far, it is evident that the embodiments are only illustrative, but are not limitative. It should be understood that a change of elements to the extent that the change may be equivalently handled without departing from the technical spirit or field of the present invention provided by the attached claims falls within the scope of the present invention.

What is claimed is:

1. A metal body antenna having loop type radiation elements and operating in a wideband in multiple bands, the metal body antenna comprising:
a housing unit adapted to form an external appearance of a terminal;
a first antenna unit adapted to comprise a first radiation element supplied with an electromagnetic signal from a first feeding power port formed in the housing unit, a ground coupled to the first radiation element by loop coupling and formed in the housing unit in which an induction current is generated, a connection point connected to the ground, and a bezel unit connected to the connection point, wherein the first antenna unit is connected to a side bezel unit forming the bezel unit and comprises an upper bezel unit having an end part open by a gap; and
a second antenna unit adapted to comprise a second radiation element supplied with an electromagnetic signal from a second feeding power port formed in the housing unit, a ground coupled to the second radiation element by loop coupling and formed in the housing unit in which an induction current is generated, a connection point connected to the ground, and a bezel unit connected to the connection point, wherein the second antenna unit is connected to a side bezel unit forming the bezel unit and comprises an upper bezel unit having an end part open by a gap.

2. A metal body antenna having loop type radiation elements, comprising:
first and second radiation elements supplied with signals from feeding power ports;
a ground coupled to the first and the second radiation elements by loop coupling, an induction current being generated in the ground;
a bezel unit separated by the ground and a dielectric; and
first and second antenna units adapted to comprise side bezel units of the bezel unit supplied with the induction current of the ground, connection points connecting the ground and the side bezel units, and an upper bezel unit connected to the side bezel units and having end parts open by gaps formed in an upper frame of the bezel unit, wherein the first and second antenna units operate in a wideband in multiple bands having an electrical length of a half wavelength.

3. A metal body antenna having loop type radiation elements and operating in a wideband in multiple bands, wherein the metal body antenna comprises a rectangular ground surface made of a metal material and an upper frame bezel unit made of a metal material and surrounding an outermost edge part of the rectangular ground surface, the metal body antenna being formed in a housing unit of a terminal and comprising:
a dielectric formed in a specific width between the rectangular ground surface and the upper frame bezel unit;
gaps each formed to maintain a specific opening at a specific portion of an upper frame of the upper frame bezel unit of the housing unit;
a first antenna unit adapted to comprise a first feeding power port which is a first port formed in a specific portion adjacent to the dielectric above the ground surface, a first radiation element connected to the first feeding power port, and supplied with an electromagnetic signal, and having an end part disconnected at a specific height with respect to the ground surface, a ground coupled to the first radiation element by loop coupling, supplied with an electromagnetic signal to generate an induction current, and formed below the first radiation element, a side bezel unit of the upper frame bezel unit connected to the ground by a connection point and separated by the dielectric, and an upper bezel unit connected to the side bezel unit and having an end part by the gap; and
a second antenna unit adapted to comprise a second feeding power port which is a second port formed in a specific portion adjacent to the dielectric above the ground surface, a second radiation element connected to the second feeding power port, and supplied with an electromagnetic signal, and having an end part disconnected at a specific height with respect to the ground surface, a ground coupled to the second radiation element by loop coupling, supplied with an electromagnetic signal to generate an induction current, and formed below the second radiation element, a side bezel unit of the upper frame bezel unit connected to the ground by a connection point and separated by the dielectric, and an upper bezel unit connected to the side bezel unit and having an end part by the gap.

4. A metal body antenna having loop type radiation elements and operating in a wideband in multiple bands, the metal body antenna comprising:
a terminal housing unit;
a metal frame bezel unit formed in an outskirt of the terminal housing unit;
a gap formed by cutting part of the frame bezel unit;
a ground spaced apart from part of the frame bezel unit separated by the gap at a specific interval, wherein part of the other side of the frame bezel unit having one side separated by the gap is connected to the ground and part of the other side of the frame bezel unit having the other side separated by the gap is connected to the ground;
a first radiation element electromagnetically coupled to the ground by loop coupling;
a second radiation element electromagnetically coupled to the ground by loop coupling;
a first feeding power port formed in the terminal housing unit, for supplying a signal of a low frequency band to the first radiation element; and
a second feeding power port formed in the terminal housing unit, for supplying a signal of a high frequency band to the second radiation element,
wherein the signal supplied from the first radiation element to the ground by loop coupling is transmitted to a frame bezel unit separated by the gap connected to the ground and radiated, and the signal supplied from the second radiation element to the ground by loop coupling is transmitted to another frame bezel unit separated by the gap connected to the ground.

5. The metal body antenna of claim 1, wherein the first radiation element and the second radiation element are formed above the ground or the dielectric in order to utilize a space and operate in a wideband in multiple bands.

6. The metal body antenna of claim 2, wherein the first radiation element and the second radiation element are formed above the ground or the dielectric in order to utilize a space and operate in a wideband in multiple bands.

7. The metal body antenna of claim 3, wherein the first radiation element and the second radiation element are formed above the ground or the dielectric in order to utilize a space and operate in a wideband in multiple bands.

8. The metal body antenna of claim 4, wherein the first radiation element and the second radiation element are formed above the ground or the dielectric in order to utilize a space and operate in a wideband in multiple bands.

9. The metal body antenna of claim 1, wherein the first radiation element coupled to the ground by loop coupling has a small size and is disposed at a specific location in a space between the end part of the bezel unit and the connection point.

10. The metal body antenna of claim 2, wherein the first radiation element coupled to the ground by loop coupling has a small size and is disposed at a specific location in a space between the end part of the bezel unit and the connection point.

11. The metal body antenna of claim 3, wherein the first radiation element coupled to the ground by loop coupling has a small size and is disposed at a specific location in a space between the end part of the bezel unit and the connection point.

12. The metal body antenna of claim 4, wherein the first radiation element coupled to the ground by loop coupling has a small size and is disposed at a specific location in a space between the end part of the bezel unit and the connection point.

13. The metal body antenna of claim 1, wherein an L-C element is inserted between the first and the second feeding power ports and the first and the second radiation elements so that impedance is matched, thereby operating in a wideband in multiple bands.

14. The metal body antenna of claim 2, wherein an L-C element is inserted between the first and the second feeding power ports and the first and the second radiation elements so that impedance is matched, thereby operating in a wideband in multiple bands.

15. The metal body antenna of claim 3, wherein an L-C element is inserted between the first and the second feeding power ports and the first and the second radiation elements so that impedance is matched, thereby operating in a wideband in multiple bands.

16. The metal body antenna of claim 4, wherein an L-C element is inserted between the first and the second feeding power ports and the first and the second radiation elements so that impedance is matched, thereby operating in a wideband in multiple bands.

17. The metal body antenna of claim 1, wherein the first and the second radiation elements are formed on both sides of the ground based on the gap and operate in a wideband in multiple bands.

18. The metal body antenna of claim 2, wherein the first and the second radiation elements are formed on both sides of the ground based on the gap and operate in a wideband in multiple bands.

19. The metal body antenna of claim 3, wherein the first and the second radiation elements are formed on both sides of the ground based on the gap and operate in a wideband in multiple bands.

20. The metal body antenna of claim 4, wherein the first and the second radiation elements are formed on both sides of the ground based on the gap and operate in a wideband in multiple bands.
